(19) United States
(12) Patent Application Publication
(10) Pub. No.: US 2009/0007721 A1
(43) Pub. Date: Jan. 8, 2009

(54) Steering Wheel with Modular Rim Assembly

(76) Inventors: Roger M. Cortina, Lasalle (CA); Steven L. Stram, Trenton, MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 12/167,811

(22) Filed: Jul. 3, 2008

Related U.S. Application Data
(60) Provisional application No. 60/948,319, filed on Jul. 6, 2007.

(51) Int. Cl. B62D 1/08

(52) U.S. Cl. 74/558

(57) ABSTRACT

A steering wheel includes a rim assembly having a pair of preformed half-shells secured to the steering wheel skeleton. Each half-shell includes an annular rigid substrate having an outer surface bordered by an inner and an outer peripheral edge, and a cover that overlies both the substrate's outer surface and its peripheral edges. When the two half-shells are mounted to the skeleton, the covered peripheral edges abut one another to provide finished inner and outer peripheral seams on the rim. Nonfunctional stitching in the covers, advantageously provided prior to covering the substrates, cooperate to simulate a functionally-stitched seam on the finished rim assembly. A decorative trim element, such as a trim ring, is mechanically captured between the opposed peripheral edges of the two half-shells. An internal passage defined within the rim assembly is advantageously used in conjunction with a Peltier device to heat and cool the rim assembly.

### CROSS-REFERENCE TO RELATED APPLICATIONS

This application claims benefit of U.S. provisional patent application No. 60/948,319 filed Jul. 6, 2007, which is assigned to the assignee of this application, and whose disclosure is hereby incorporated by reference.

### FIELD OF THE INVENTION

The invention relates to a steering wheel, and more particularly, to a steering wheel having a modular rim assembly.

### BACKGROUND OF THE INVENTION

To impart steering wheels with a high-quality feel and appearance, it is known to provide the steering wheel rim with various decorative elements having a variety of attractive surfaces, e.g., wood grain, aluminum and chrome. Such decorative surfaces are often combined with a leather coating of the steering wheel rim.

Known steering wheel designs, such as described in U.S. Pat. No. 6,761,086 B2, include a rigid skeleton whose outermost portion is surrounded by an injection molded sheathing material to thereby define the steering wheel's outer rim. The sheathing material is typically injection molded polyurethane or other similar foam that is overmolded onto the skeleton using specialized equipment. In some known designs, the overmolded sheathing is then surrounded by a suitable cover material, such as vinyl or leather, typically in a labor-intensive manual operation; and then perhaps the covered sheathing is capped with a rigid decorative element that is either secured directly to the underlying skeleton or otherwise retained on the sheathing or underlying skeleton by a plurality of internal clips.

A need exists to provide a simple and more cost-effective steering wheel assembly without the need for applications of a molded foam sheathing material and which can be produced/assembled at a favorable cost.

### SUMMARY OF THE INVENTION

Under the invention, a steering wheel includes a rigid skeleton and a rim assembly supported by the skeleton. The rim assembly includes a pair of annular half-shells, wherein each half-shell includes a preformed rigid substrate having an outer surface bordered by a pair of peripheral edges, and a cover overlying both the outer surface and the peripheral edges of the substrate. Each half-shell further includes a cover overlying both the outer surface and each peripheral edge of the substrate. The cover, which is formed of a suitable flexible material such as a leather or vinyl material, or a relatively-inflexible plastic or wood applique, or a combination of both, is preferably secured to the substrate With a suitable adhesive.

Each half-shell, with its overlaid cover, is directly secured to the skeleton with the respective peripheral edges of the two half-shells generally placed in opposition with one another. The generally-opposed peripheral edges of the two half-shells, as secured to the skeleton, define the rim assembly's finished peripheral seams, either alone or with a further decorative element, such as a trim ring, captured between the generally-opposed half-shell edges.

In accordance with an aspect of the invention, features or decorative elements are readily added to the cover before the cover is overlaid on the half-shell's substrate. For example, in a preferred embodiment, the flexible cover of each half-shell is nonfunctionally stitched along one of its edges and then is stretched over the substrate such that the stitching overlies the substrate proximate to one of the peripheral edges. When the two half-shells are mounted on the skeleton, the stitching on the two half-shells cooperates to simulate a rim assembly with a functionally-stitched cover.

In accordance with another aspect of the invention, each half-shell preferably includes a layer of a sheathing material disposed between the outer surface of its rigid substrate and the cover, to thereby provide rim assembly with a relatively-softer “feel.” By way of example only, in a preferred embodiment, a relatively-shallow recess is defined in the outer surface of the rigid substrate, and a foam sheet is disposed within the recess and is secured within the recess by a suitable adhesive.

In accordance with another aspect of the invention, when the half-shells are brought together and secured to the skeleton to thereby define the steering wheel's rim, an inner surface of the rigid substrate of one half-shell is spaced from the skeleton and/or the inner surface the other half-shell's rigid substrate. An internal, peripheral passageway is thus defined within the rim. In addition to beneficially reducing the nominal weight of the resulting steering wheel, the passageway is advantageously used to heat or cool the steering wheel rim, for example, in combination with a steering wheel-mounted fan and Peltier device.

In accordance with another aspect of the invention, in another preferred embodiment, the covered outer surface of one half-shell defines a significantly greater portion of the surface area of the resulting steering wheel rim than the outer surface of the other half-shell. Thus, for example, in a preferred embodiment, the front half-shell is configured to define approximately sixty-five percent or more of the periphery of the rim when the rim is viewed in radial cross-section at a location other than proximate to a spoke. It is noted that, when this preferred embodiment is mounted in a vehicle, the inner peripheral seam defined by the two half-shells lies roughly in the geometric middle of the rim, while the outer peripheral seam lies forward of the geometric middle of the rim, away from the vehicle operator and, hence, in a less easily-viewed position on the rim.

In accordance with another aspect of the invention, a method for assembling a steering wheel rim on an outer portion of a steering wheel skeleton includes, in no particular order, covering both the outer surface and the peripheral edges of each of two rigid annular substrates with a respective cover, and attaching the first substrate to the outer portion of the skeleton. With the covered first substrate (forming a first covered half-shell as described above) thus attached to the skeleton, and with the second substrate thus covered (forming the second covered half-shell as described above), the method further includes attaching the second covered substrate to the outer portion of the skeleton such that the covered peripheral edges of the first covered substrate are respectively placed in general opposition to the covered peripheral edges of the second covered substrate, to thereby define two peripheral seams on the rim.

In accordance with yet another aspect of the invention, in a preferred embodiment employing a leather cover, the covering step includes stretching the cover and folding the cover over the peripheral edges of the substrate. By way of example, in the preferred method, stretching includes positioning the cover in a recess of a jig (and, perhaps, retained within the recess by means of an applied vacuum), and pressing the outer surface of the substrate into the recess. Preferably, the covering step includes applying an adhesive to at least one of the cover and the outer surface of the substrate, prior to stretching the cover over the outer surface of the substrate. Where the use of a sheathing material beneath the cover is desirable to improve the rim's “feel,” the method further preferably also includes attaching a layer of a sheathing material onto the outer surface of at least one of the first and second substrates before covering.

In accordance with yet another aspect of the invention, where a decorative stitching along one or both of the rim assembly's seams is desired, the method further includes stitching the first and second covers before covering, while the covering step also includes positioning the stitching on the first and second covers proximate one of the radially-inner seam and the radially-outer seam. In this manner, the covers are easily stitched prior to covering the rim while still providing the steering wheel with a simulated stitched rim seam.

In accordance with a further aspect of the invention, a preferred method of assembling a steering wheel rim includes positioning a decorative element proximate to one of the peripheral edges of the first half-shell prior to attaching the second half-shell to the skeleton, whereby the trim element is mechanically captured between the first and second half-shells.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

Various aspects of the invention will become more fully understood from the detailed description and the accompanying drawings, wherein:

FIG. 1 is a perspective view of a first exemplary steering wheel in accordance with the invention;

FIG. 2 is an exploded perspective view of first steering wheel of FIG. 1;

FIG. 3 is a front view of the first steering wheel of FIG. 1;

FIGS. 4-8 are radial sectional views of the first steering wheel's rim assembly taken along lines 4-4, 5-5, 6-6, 7-7, and 8-8 of FIG. 1, respectively;

FIG. 9 is a partial view of one of the second steering wheel's spokes, partially broken away to show a Peltier device and a fan used to direct heated or cooled air through the annular passageway defined within the rim assembly between the two half-shells;

FIG. 10 is a perspective view of a second exemplary steering wheel in accordance with the invention, with its outer peripheral seam shifted further away from the “front” side of the steering wheel's rim assembly;

FIGS. 11-13 are radial sectional views of the second steering wheel's rim assembly, similar to those of FIGS. 4-6;

FIG. 14 is a radial sectional view, similar to that of FIG. 11, showing an alternative configuration for the inner surface of the rim assembly's front half-shell;

FIG. 15 is an enlarged view of the simulated stitching proximate to the first steering wheel's inner peripheral seam;

FIG. 16 is an enlarged view, similar to that of FIG. 15, showing an alternative pattern for the simulated stitching proximate to the inner peripheral seam;

FIG. 17 is a perspective view of a third exemplary steering wheel in accordance with the invention, incorporating a decorative ring captured between its two half-shells;

FIG. 18 is an exploded perspective view of third steering wheel of FIG. 17;

FIG. 19 is a radial sectional view of the third steering wheel of FIG. 17, showing the captured decorative ring;

FIG. 20 is a radial section view of a fourth steering wheel in accordance with the invention, showing yet another contemplated variation of the rim assembly's two half-shells; and

FIGS. 21-26 are several views of a pair of fixtures used to stretch a cover over the outer surface of each half-shell.

### DETAILED DESCRIPTION OF THE PREFERRED EMBODIMENTS

The following description of the preferred embodiments is merely exemplary in nature and is in no way intended to limit the invention, its application, or uses.

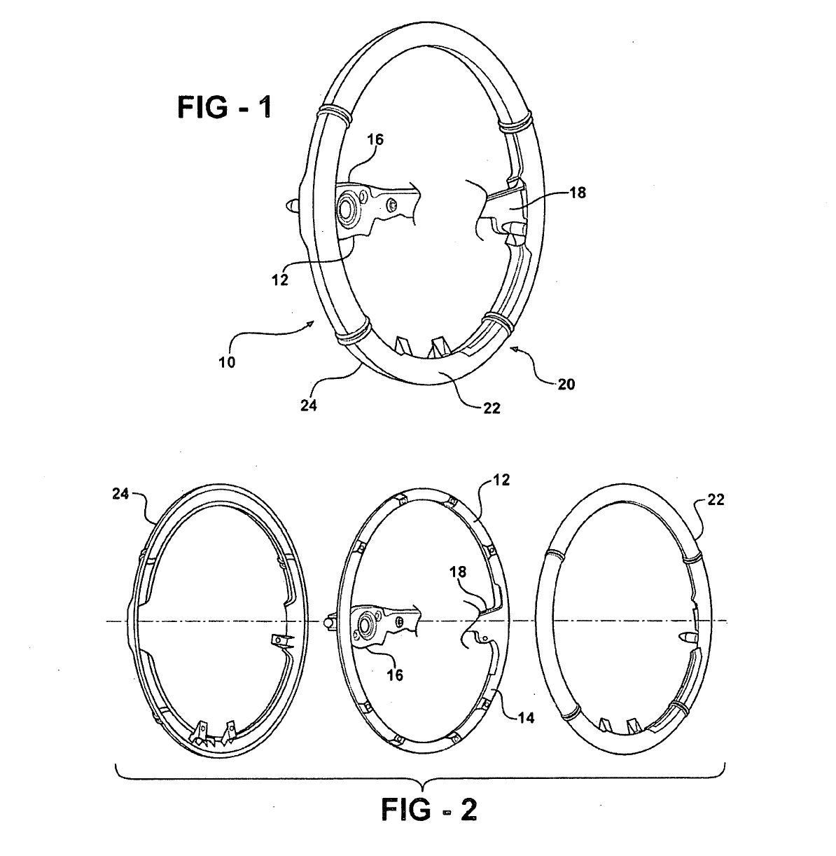

Referring to FIGS. 1 and 2, a first exemplary steering wheel 10 in accordance with the invention includes an armature or skeleton 12 having an annular outer portion 14 that is connected to a central hub 16 by a pair of spokes 18. The first steering wheel 10 also includes a rim assembly 20 that encapsulates the outer portion 14 of the skeleton 12.

The rim assembly 20 includes a front preformed half-shell 22 and a rear half-shell 24. While each half-shell 22, 24 may be formed of any suitable material, in the first steering wheel 10, each half-shell 22, 24 is conveniently formed of an injection-molded plastic. Other suitable materials include, without limitation, sheet-molded plastic, fiber-reinforced composite materials, and cast and stamped metal. Also, and as best seen in FIG. 2, while each half-shell 22, 24 may be monolithic, each of the first steering wheel's half-shells 22, 24 are assembled from separately-formed arcuate segments, whereby the half-shells are readily modified, for example, to include a selected surface feature (such as ridges) or characteristic (such as surface compressibility to achieve a desired “feel”), or to optionally define mounting locations for rim-mounted controls (thereby eliminating the need for separate bezels or switch housings on the resulting steering wheel rim).

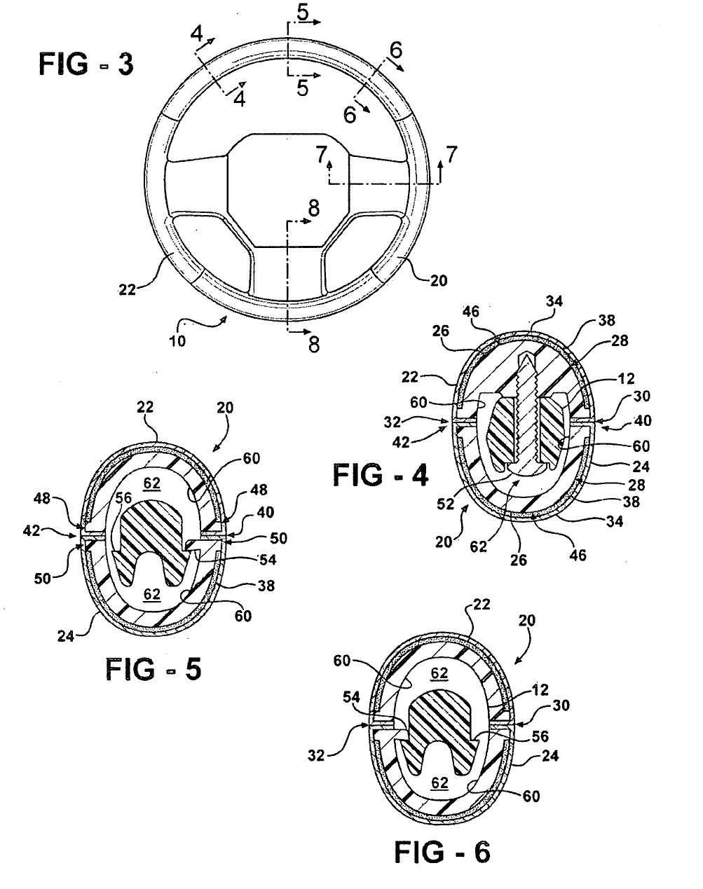

As best seen in FIGS. 3-8, each half-shell 22, 24 includes a rigid substrate 26 having an outer surface 28 bordered by an inner peripheral edge 30 and an outer peripheral edge 32, and a cover 34 overlying both the outer surface 28 and the peripheral edges 30, 32 of the substrate 26. Each half-shell 22, 24 also includes a layer of a sheathing material, such as a foam sheet 38, disposed between the substrate's outer surface 28 and the cover 34, to thereby provide the rim assembly 20 with a relatively-softer “feel.” When the half-shells 22, 24 are brought together and secured to the outer portion 14 of the skeleton 12 as discussed further below, the generally-opposed inner and outer peripheral edges 30, 32 of the two half-shells 22, 24 generally abut one another to provide finished inner and outer peripheral seams 40, 42.

As best seen in FIGS. 4-8, the foam sheet 38 is disposed in a relatively-shallow recess 46 defined in the outer surface 28 of each half-shell substrate 26. Thus, as seen in FIG. 3, the recess 46 preferably does not extend all the way to the substrate's peripheral edges 30, 32 (at least, along those portions of the rim assembly 20 remote from the skeleton's spokes 18), such that a pair of inner and outer peripheral lands 48, 50 on the substrate 26 serve to define the relatively “hard” edges proximate to the rim assembly's inner and outer peripheral seams 40, 42. An adhesive (not shown) is used to secure the foam sheet 38 within the recess 46.

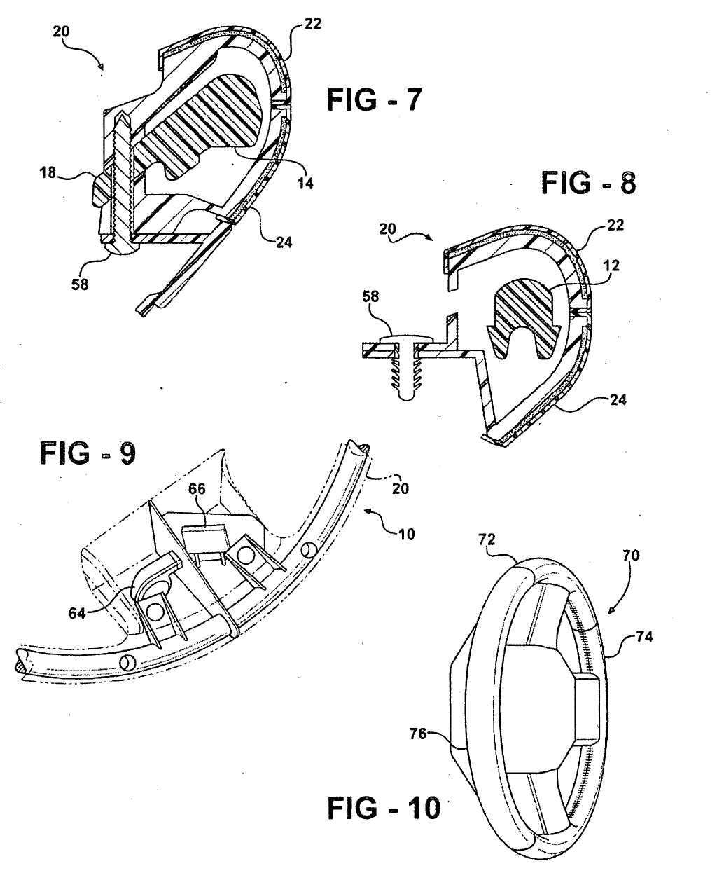

Referring again to FIGS. 2 and 4, the front half-shell 22 is fixedly secured directly to the outer portion 14 of the skeleton 12 with a plurality of threaded fasteners 52. And, as best seen in FIGS. 5 and 6, in the first steering wheel 10, the substrate 26 of the rear half-shell 24 includes a plurality of circumferentially-staggered opposed snap hooks 54 proximate to its inner and outer peripheral edges 30, 32, in alignment with complementary detents 56 disposed on the outer portion 14 of the skeleton 12, whereby the snap hooks 54 engage the detents 56 to lock the rear half-shell 24 to the skeleton 12 in a close relationship with the front half-shell 22. And, as best seen in FIGS. 7 and 8, additional fasteners 58 preferably further serve to secure the rear half-shell 24 directly to the front half-shell 22, for example, in an area proximate the skeleton's spokes 18.

Referring again to FIGS. 4, 5, and 6, when the half-shells 22, 24 are secured to the outer portion 14 of the skeleton 12, an inner surface 60 of each half-shell's rigid substrate 26 is spaced from the skeleton 12 and the inner surface 60 of the other half-shell's rigid substrate 26. An internal, peripheral passageway 62 is thus defined within the rim assembly 20. As seen in FIG. 9, in addition to beneficially reducing the nominal weight of the resulting steering wheel 10, the passageway 62 is advantageously used to heat or cool the steering wheel rim with heated or cooled forced air, upon operation of a fan 64 and Peltier device 66 conveniently housed within one of the first steering wheel's spokes 68. It will also be appreciated that the peripheral passageway 62 advantageously provides a route through which suitable connections to any rim-mounted controls (not shown) may be effected.

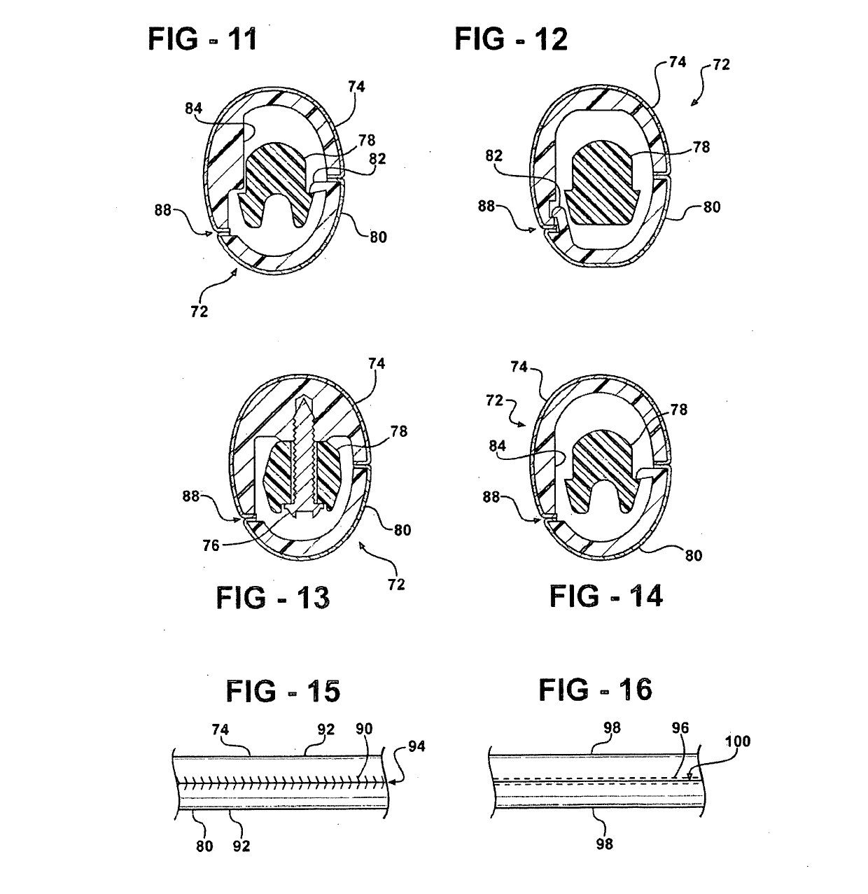

Referring to FIGS. 10-16, a second exemplary steering wheel 70 similarly includes a rim assembly 72 that is defined by a front half-shell 74 that is directly secured by fasteners 76 to a steering wheel skeleton 78, and by a rear half-shell 80 that is directly secured to both the skeleton 78 and to the front half-shell 72 by circumferentially-staggered snap hooks 82. FIGS. 11 and 14 show alternative configurations for portions of the inner surface 84 of the front half-shell 74.

Significantly, as best seen in FIGS. 10-14, the second steering wheel's front half-shell 74 defines a significantly greater portion of the surface area of the resulting steering wheel rim assembly 72 than the corresponding outer surface of the rear half-shell 80. Thus, when the second steering wheel 70 is mounted in a vehicle, the radially-inner mating edges of the two half-shells 74,80 meet to define an inner peripheral seam 86 that is located roughly in the geometric middle of the rim, while the radially-outer mating edges of the two half-shells 74,80 meet to define an outer peripheral seam 88 that is shifted away from the vehicle operator, to a point forward of the geometric middle of the rim. In this way, the second steering wheel features an outer peripheral seam 88 that is less easily-viewed by the operator than the outer peripheral seam 42 of the first steering wheel 10 illustrated in FIGS. 1-9, to thereby provide the second steering wheel 70 with a nearly-seamless outer periphery when viewed from the vehicle operator's position.

FIG. 15 is an enlarged, partial view of the second steering wheel's inner peripheral seam, showing the manner in which stitching 90 is defined in each half-shell cover 92 before the half-shells 74,80 are respectively secured to the skeleton 78 (and, indeed, preferably defined in each half-shell cover 92 before the cover 92 is applied to the half-shell's substrate). When the half-shells 74, 80 are secured to the skeleton, the opposed inner peripheral edges of the two half-shells 74, 80 cooperate to simulate a functionally-stitched steering wheel cover proximate to the rim assembly's inner peripheral seem 94. FIG. 16 is a similar enlarged, partial view of an alternative stitching 96 that may be advantageously defined in each half-shell cover 98 before the cover 98 is itself applied to its substrate, to provide the illustrated stitch pattern to likewise simulate a functionally-stitched inner peripheral seam 100.

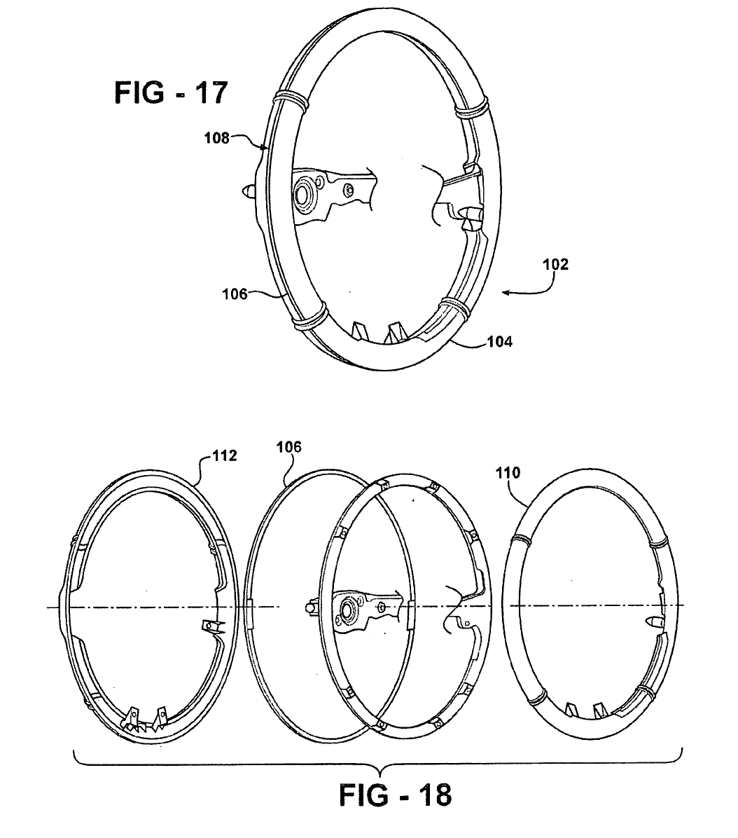

Referring to FIGS. 17-19, a third exemplary steering wheel 102 has a rim assembly 104 with a decorative ring 106 positioned about the outer periphery of the steering wheel 102 in overlapping relationship with respect to the outer peripheral seam 108 formed between the skeleton-mounted front and rear half-shells 110, 112. As best seen in FIG. 19, the decorative ring 106 is mechanically captured between the opposed outer peripheral edges 114,116 of the two half-shells 110, 112. The decorative ring 106 thus also overlies a radially-outer portion of the cover 118 of each half-shell 110, 112, thereby advantageously serving to further secure the covers 118.

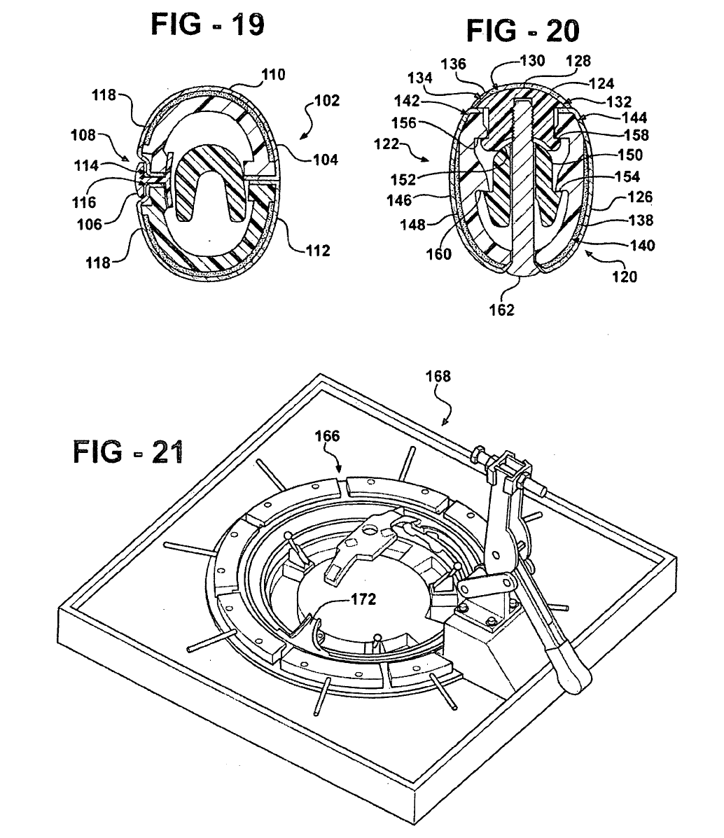

FIG. 20 is an illustration of a radial sectional view of a rim assembly 120 of a fourth exemplary steering wheel 122, wherein the front half-shell 124 defines a significantly smaller portion of the rim assembly's final surface area than the rear half-shell 126. In the fourth steering wheel 122, the front half-shell 124 includes an injection-molded substrate 128 whose outer surface 130 and bordering peripheral edges 132, 134 are covered by a wood veneer 136 (adhesive not shown). The fourth steering wheel's rear half-shell 126 includes an injection-molded substrate 138 whose outer surface 140 and bordering upper and lower peripheral edges 142, 144 are covered with a leather cover 146. A layer of foam sheathing 148 underlies much of the leather cover 146 of the rear half-shell 126, but does not underlie the cover 146 as it approaches and overlies the substrate's upper and lower peripheral edges 142, 144.

Upon assembly, the covered front half-shell 124 is first secured directly to the steering wheel skeleton 150, for example, with an adhesive 152, whereupon the covered rear half-shell 126 is spread slightly over the skeleton's detents 154 and advanced until both a first set of snap hooks 156 engages complementary detents 158 defined in the front half-shell 124, and a second set of snap hooks 160 engages the skeleton's detents 154. A plurality of circumferentially-spaced fasteners 162 further serve to secure the rear half-shell 126 to the front half-shell 124.

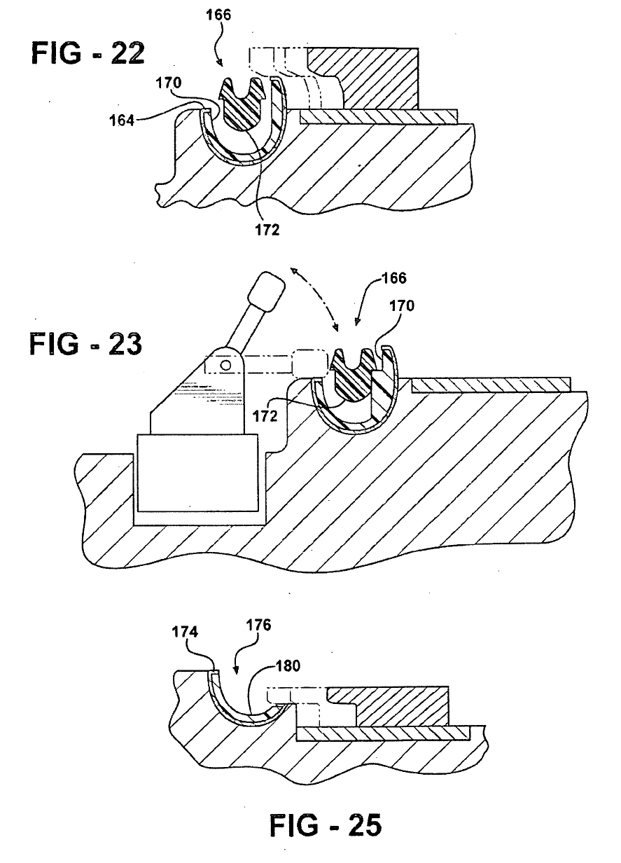

Referring to FIGS. 21-23, a preferred method for making the first exemplary steering wheel of FIGS. 1-9 includes covering an outer surface and the bordering peripheral edges of a first rigid annular substrate, or an arcuate portion of such a substrate, with a first cover, and attaching the first substrate to the outer portion of the skeleton. Specifically, the preferred method includes placing a first strip of a leather 164 within a contoured recess 166 of a first jig 168 that corresponds in shape to the rim assembly's front half-shell, applying a suitable adhesive (not shown) to the exposed face of the leather strip 164, and pressing and holding the front half-shell's preformed substrate 170 into the recess 166 such that an outer surface of the substrate 170 is placed in opposition with the recess 166, and the leather strip 168 is stretched taut to thereby cover the peripheral edges of the front half-shell. The edges of the leather strip 164 are then folded inwardly over the substrate's inner and outer peripheral edges. In the preferred method, the steering wheel skeleton 172 is preferably secured to the front half-shell before application of the cover, as the skeleton 172 can thereafter be advantageously used to press the front half-shell into the recess.

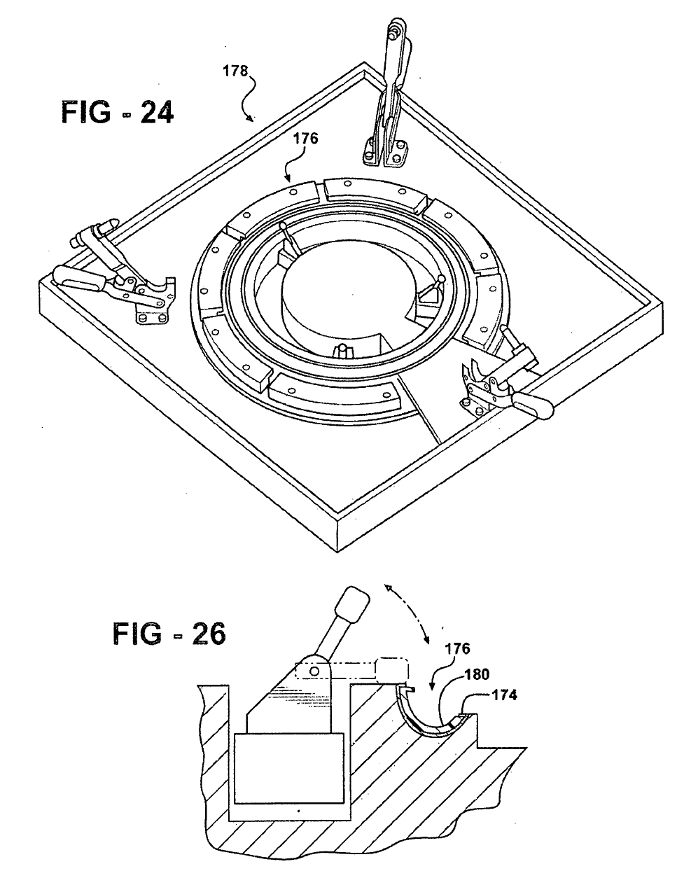

Referring to FIGS. 24-26, the preferred method includes placing a second strip of a leather 174 within a contoured recess 176 of a second jig 178 that corresponds in shape to the rim assembly's rear half-shell. The preferred method further includes applying a suitable adhesive to the exposed face of the leather strip 174, and pressing and holding the rear half-shell's preformed substrate 180 into the recess 176 such that an outer surface of the substrate 180 is placed in opposition with the recess 176, and the leather strip 174 is stretched taut to thereby cover the peripheral edges of the rear half-shell.

The preferred method further includes attaching the rear half-shell's covered substrate to the outer portion of the steering wheel skeleton 172 such that its covered peripheral edges are respectively placed in general opposition to the covered peripheral edges of the front half-shell's substrate, to thereby respectively define a radially-inner seam and a radially-outer seam on the rim.

The description of the invention is merely exemplary in nature and, thus, variations that do not depart from the gist of the invention are intended to be within the scope of the invention. Such variations are not to be regarded as a departure from the spirit and scope of the invention. For example, while the half-shells of the disclosed embodiments are each permanently secured to the skeleton, the invention also contemplates removably securing one or both half-shells to the skeleton, for example, to facilitate access to rim-mounted controls. Similarly, the invention contemplates use of a wide variety of sheathing and cover materials, including overmolded polyurethane, and other materials whose outer surfaces can be molded to impart the outer surface with a desired appearance, as applied about the half-shells subsequent to directly securing the half-shells to the skeleton.

What is claimed is:

1. A steering wheel comprising:
a rigid skeleton having a hub, and an outer portion connected to the hub by a plurality of spokes; and
a rim assembly including a first and a second annular half-shell, each half-shell including a rigid substrate having an outer surface bordered by a pair of peripheral edges, and a cover layer overlying both the outer surface and peripheral edges of the substrate;
wherein the first and second half-shells are respectively secured to the outer portion of the skeleton such that one peripheral edge of the first half-shell is positioned generally in opposition to one peripheral edge of the second half-shell to thereby define an inner peripheral seam, and the other peripheral edge of the first half-shell is positioned generally in opposition to the other peripheral edge of the second half-shell to thereby define an outer peripheral seam.

2. The steering wheel of claim 1, wherein the first half-shell is secured to the skeleton by a first plurality of fasteners.

3. The steering wheel of claim 2, wherein the first half-shell is further directly secured to the second half-shell by a second plurality of fasteners.

4. The steering wheel of claim 1, wherein the skeleton includes a plurality of detents, and the substrate of the second half-shell includes a plurality of snap hooks adapted to engage the detents of the skeleton, whereby the second half-shell is secured to the skeleton upon engagement of the snap hooks of the second half-shell with the detents of the skeleton.

5. The steering wheel of claim 1, wherein the one peripheral edge of the first half-shell directly abuts the one peripheral edge of the second half-shell.

6. The steering wheel of claim 1, wherein the other peripheral edge of the first half-shell directly abuts the other peripheral edge of the second half-shell.

7. The steering wheel of claim 1, further including a decorative element disposed between the first and second half-shells.

8. The steering wheel of claim 1, wherein the cover of the first half-shell defines a significantly greater surface area on the rim assembly than the cover of the second half-shell.

9. The steering wheel of claim 1, wherein at least one half-shell further includes a layer of a sheathing material disposed between the outer surface of the rigid substrate and the cover layer.

10. The steering wheel of claim 9, wherein the sheathing material is a foam sheet.

11. The steering wheel of claim 9, wherein the outer surface of the substrate of the at least one half-shell includes a recess remote from at least one of the peripheral edges of the substrate, and wherein the layer of sheathing material is disposed only in the recess.

12. The steering wheel of claim 1, further including an internal peripheral passageway defined between the substrate of the first and second half-shells and the outer portion of the skeleton.

13. A method for assembling a steering wheel rim on an outer portion of a steering wheel skeleton, the method comprising:
covering an outer surface and adjacent peripheral edges of a first rigid annular substrate with a first cover,
attaching the first substrate to the outer portion of the skeleton;
covering an outer surface and adjacent peripheral edges of a second rigid annular substrate with a second cover; and
after both covering and attaching the first substrate, and covering the second substrate, attaching the second substrate to the outer portion of the skeleton, such that the covered peripheral edges of the first substrate are respectively placed in general opposition to the covered peripheral edges of the second substrate, to thereby respectively define a first peripheral seam and a second peripheral seam on the rim.

14. The method of claim 13, wherein covering includes stretching the cover and folding the cover over the peripheral edges of the substrate.

15. The method of claim 14, wherein stretching includes positioning the cover in a recess, and pressing the outer surface of the substrate into the recess.

16. The method of claim 15, wherein covering further includes applying an adhesive to at least one of the cover and the outer surface of the substrate.

17. The method of claim 13, further including attaching a layer of a sheathing material onto the outer surface of at least one of the first and second substrates before covering.

18. The method of claim 13, further including stitching the first and second covers before covering, and wherein covering includes positioning the stitching on the first and second covers proximate one of the radially-inner seam and the radially-outer seam, whereby the stitching on the first and second covers cooperate to simulate a stitched peripheral seam.

19. The method of claim 13, further including positioning a trim element proximate to one of the peripheral edges of the first half-shell prior to attaching the second half-shell, whereby the trim element is mechanically captured between the first and second half-shells.

20. The method of claim 13, wherein one of the half-shells includes a plurality of arcuate segments connected end-to-end, and wherein attaching the one half-shell includes sequentially attaching each of the arcuate segments to the outer portion of the skeleton.
